(19) United States
(12) Patent Application Publication
(10) Pub. No.: US 2008/0111083 A1
(43) Pub. Date: May 15, 2008

(54) SCINTILLATOR PANEL, PRODUCTION METHOD OF THE SAME AND RADIATION IMAGE SENSOR

(76) Inventors: Masashi Kondo, Tokyo (JP); Takehiko Shoji, Tokyo (JP); Mitsuru Sekiguchi, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/937,878

(22) Filed: Nov. 9, 2007

(30) Foreign Application Priority Data
Nov. 14, 2006 (JP) JP2006-307741

(51) Int. Cl. G01T 1/24

(52) U.S. Cl. 250/370.11

(57) ABSTRACT

A scintillator panel containing a substrate having thereon a reflection layer, and intermediate layer, and a scintillator layer in the sequence set forth, wherein the intermediate layer contains a resin having a glass transition temperature, and the intermediate layer has been subjected to a process of heating to a temperature of equal to or grater than the glass transition temperature of the resin.

This application is based on Japanese Patent Application No. 2006-307741 filed on Nov. 14, 2006 with Japan Patent Office, the entire content of which is hereby incorporated by reference.

### TECHNICAL FIELD

The present invention relates to a scintillator panel employed to form a radiation image for a subject, a radiation image sensor employing the same, and a production method of the scintillator panel.

### BACKGROUND

Hitherto, radiation images such as X-ray images have been widely employed in the medical field for diagnosis of diseases. Specifically, an intensifying screen-film radiation image capturing system is still being used worldwide in the medical field as an image capturing system due to its high reliability as well as superior cost performance since improvements in sensitivity and image quality have been achieved in the long history of the system.

However, image data obtained using this system are so called analog image data that are not suitable for easy image processing or instantaneous image transfer, compared to digital image data, which have been developed in recent years.

Recently, digital radiation image detectors, represented by a computed radiography (CR) system and a flat panel radiation detector (FPD), have been marketed. These systems are capable of directly capturing digital radiation images, and of directly displaying the images on an image display device such as a cathode ray tube or a liquid crystal panel.

Consequently, these digital X-ray image detectors have reduced the necessity for image formation based on silver halide photography, as well as having greatly improved the convenience of diagnosis in hospitals and medical clinics.

Currently, a computed radiography (hereinafter referred to as CR) system is being employed in the medical field. However, the system exhibits poor image sharpness and imperfect spatial resolution, whereby its image quality has not reached the level having been attained by the intensifying screen-film system.

Further, as new digital X-ray imaging technologies, flat panel X-ray detectors (FPDs) utilizing thin film transistors (TFTs) have been developed, as described in, for example, “Amorphous Semiconductor Usher in Digital X-ray Imaging”, John Rowlands et al., Physics Today, p24 (November, 1997), and “Development of a High Resolution, Active Matrix, Flat-Panel Imager with Enhanced Fill Factor”, L. E. Antonuk, SPIE, Vol. 32, P2 (1997).

Flat panel radiation detectors (hereinafter referred to as FPDs) are characterized by being more compact than CR systems, and by exhibiting superior image quality at high radiation doses to the latter. These FPDs, provided with a photodetector facing an emitting substance layer, incorporate a phosphor layer, which emits fluorescence via irradiation of radioactive rays.

Further, to increase efficiency of the photodetector, a structure incorporating a reflection layer, together with a phosphor layer is known, in which a metallic film such as aluminum is utilized as the reflection layer.

In some cases when a metallic film such as aluminum is utilized as the reflection layer, alterations due to moisture occur, resulting in a decrease in function of the reflection layer. To prevent such problems, a structure incorporating a protective layer is known (refer to Patent Document 1).

Namely, known is a radiation detector apparatus containing a photodetector located in a position facing a phosphor layer (being a scintillator layer), which is formed on a protective film covering a thin reflective metallic film formed on the phosphor layer substrate.

However, there has been the following problem: in a radiation detector featuring such a structure, its photo detecting function occasionally suffers impact damage.

(Patent Document 1) Japanese Patent Publication Open to Public Inspection No. 2000-356679

### SUMMARY

An object of the present invention is to provide a scintillator panel exhibiting excellent impact resistance, a production method thereof, and a radiation image sensor.

An object of the present invention is achieved via the following constitutions:
1. In a scintillator panel incorporating a substrate, a reflection layer formed thereon, an intermediate layer formed on the reflection layer, and a scintillator layer formed on the intermediate layer, the scintillator panel being characterized in that the intermediate layer, containing a resin having a glass transition temperature, has been subjected to a process of heating to at least the glass transition temperature of the resin;
2. The scintillator panel, described in 1., wherein the glass transition temperature of the resin is in the range of 30° C.-100° C.;
3. The scintillator panel, described in 1. or 2., wherein the resin having the glass transition temperature is a polyester resin;
4. The scintillator panel, described in any one of 1.-3., wherein the thickness of the intermediate layer is in the range of 0.2 μm-2.5 μm;
5. The scintillator panel, described in any one of 1.-4., wherein the reflection layer is an aluminum-incorporating film;
6. The scintillator panel, described in any one of 1.-5., wherein the shape of the surface of the intermediate layer on the scintillator layer side is thermally deformed via a process of heating the intermediate layer to at least the glass transition temperature of the resin to conform to the shape of the surface of the scintillator layer facing the intermediate layer;
7. A radiation image sensor provided with a photodetector facing the scintillator layer of the scintillator panel, described in any one of 1.-6.; and
8. In a production method of the scintillator panel, described in any one of 1.-6., the production method, wherein the scintillator layer is a layer formed via a deposition process, and the process of heating to at least the glass transition temperature, described above, is carried out during the deposition process.

### BRIEF DESCRIPTION OF THE DRAWINGS

FIG. 1 is a cross-sectional view showing a schematic structure of a scintillator panel.

FIG. 2 is a cross-sectional view showing a schematic structure of a radiation image sensor.

FIG. 3 is a constitutional view showing a schematic structure of a deposition apparatus.

FIG. 4 is a schematic cross-sectional view showing an example of the shape of the thermally deformed surface of an intermediate layer which conforms to the shape of the surface of the scintillator layer.

### DESCRIPTION OF THE PREFERRED EMBODIMENT

According to the present invention, in a scintillator panel incorporating a substrate, a reflection layer formed thereon, an intermediate layer formed on the reflection layer, and a scintillator layer formed on the intermediate layer, the intermediate layer, containing a resin having a glass transition temperature, is characterized by having been subjected to a process of heating to at least the glass transition temperature of the resin.

In the present invention, the intermediate layer is specifically arranged between the reflection layer and the scintillator layer, in which the intermediate layer has been subjected to a process of heating to at least the glass transition temperature of the resin, whereby it is possible to produce a scintillator panel exhibiting excellent impact resistance.

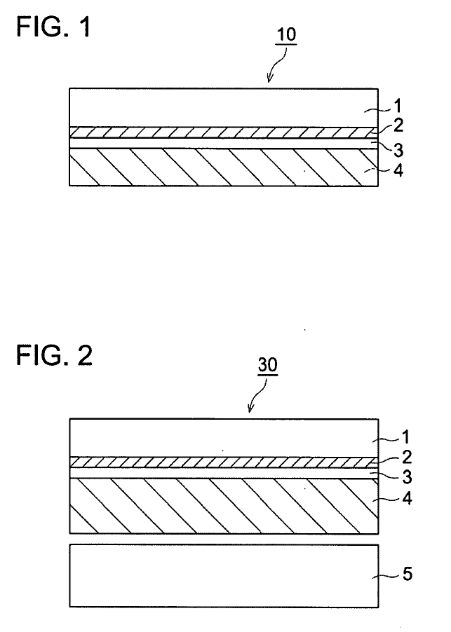

With reference to FIGS. 1-4, the best embodiment to achieve the present invention will now be described; however the scope of the present invention is not limited to the drawings exemplified below.

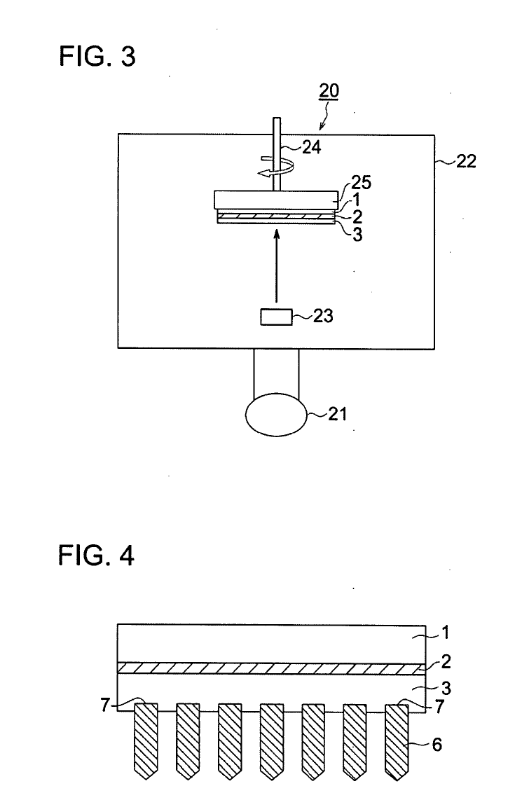

FIG. 1 is a cross-sectional view showing a scintillator panel. FIG. 2 is a cross-sectional view showing a schematic structure of a radiation image sensor. FIG. 3 is a schematic view showing a production method of the scintillator panel of the present invention. FIG. 4 is an exemplary view showing the shape of the surface of an intermediate layer on the scintillator layer side.

As shown in FIG. 1, a scintillator panel 10 incorporates a reflection layer 2 formed on a substrate 1, an intermediate layer 3 formed on the reflection layer 2, and a scintillator layer 4 formed on the intermediate layer 3.

(Substrate)

The substrate of the present invention is a plate-like film, capable of supporting a reflection layer, which transmits at least 10% of radioactive rays such as X-rays, based on the incident dose.

Various types of glass, polymeric materials, and metals may be utilized as the substrate. Preferred examples include various plate glass such as quartz glass, borosilicate glass, or chemically-strengthened glass; ceramic substrates such as sapphire, silicon nitride, or silicon carbide; semiconductor substrates such as silicon, germanium, gallium arsenide, gallium phosphide, or gallium nitride; plastic film such as cellulose acetate film, polyester film, polyethylene terephthalate film, polyamide film, polyimide film, triacetate film, polycarbonate film, or carbon fiber reinforced resin sheet; metal sheets such as aluminum, iron, or copper; or metal sheets carrying a coated layer of a metallic oxide.

Of these, from the viewpoint of durability and reduced weight, aluminum sheet, carbon fiber reinforced resin sheet, and polyimide film are preferable.

Further, the thickness of the substrate is preferably in the range of 50 μm-500 μm from the viewpoint of increased durability and reduced weight.

(Reflection Layer)

When the scintillator panel 10 is irradiated with radioactive rays from the side of the substrate 1 toward the side of the scintillator layer 4, the energy of the radioactive rays, having entered into the scintillator layer 4, is absorbed by a phosphor in the scintillator layer 4, and then the scintillator layer 4 emits electromagnetic waves (light), which are generated by the phosphor, according to the intensity of the incident radioactive rays.

Some emitted electromagnetic waves reach the surface (namely the emission surface) opposite to the incident surface of the radioactive rays in the scintillator layer, and other ones travel toward the side of the substrate 1.

The reflection layer 2 of the present invention is a layer, capable of reflecting the electromagnetic waves which are emitted toward the side of the substrate 1.

Thin metallic films are preferably employed for the reflection layer. As the thin metallic films, films incorporating materials containing a substance selected from the group including aluminum, silver, chromium, copper, nickel, titanium, magnesium, rhodium, platinum, and gold are preferably utilized. Further, the thin metallic films may be formed into at least two layers in such a manner that a gold film is formed on a chromium film.

Of these, specifically, an embodiment, in which a film incorporating aluminum is utilized as the reflection layer, is preferable according to the present invention.

(Intermediate Layer)

The intermediate layer of the present invention is a layer arranged between the reflection layer and the scintillator layer. The intermediate layer, containing a resin having a glass transition temperature, has been subjected to a process of heating to at least the glass transition temperature of the resin.

The glass transition temperature of the present invention is determined using a differential scanning calorimeter under a condition of elevating temperature at a rate of 5° C./min.

Resins having the glass transition temperature of the present invention are ones having the glass transition temperature defined above, including polyester resins, polyacrylic acid copolymers, polyacrylamide, or derivatives and partial hydrolysates thereof; vinyl polymers such as polyvinyl acetate, polyacrylonitrile, or polyacrylates, and copolymers thereof; and natural products such as rosin or shellac, and derivatives thereof.

Further, styrene-butadiene copolymers, polyacrylic acid, polyacrylates, and derivatives thereof; emulsions of polyvinyl acetate, vinyl acetate-acrylate copolymers, polyolefins, or olefin-vinyl acetate copolymers are also employable. In addition, carbonate, polyester, urethane, and epoxy based resins, polyvinyl chloride, polyvinylidene chloride, and organic semiconductors such as polypyrrole. Of these, polyester resins are preferable.

The polyester resins are specifically exemplified as polybasic acids including saturated polybasic acids such as phthalic anhydride, terephthalic acid, isophthalic acid, tetrachlorophthalic anhydride, hexachloro-endomethylene tetrahydrophthalic anhydride, dimethylene tetrahydrophthalic acid, succinic acid, adipic acid, or sebacic acid; or unsaturated polybasic acids such as maleic acid, maleic anhydride, fumaric acid, itaconic acid, or citraconic anhydride. The polyester resins are further exemplified as dihydric alcohols such as ethylene glycol, diethylene glycol, triethylene glycol, propylene glycol, 1,3-butylene glycol, 2,3-butylene glycol, 1,4-butylene glycol, trimethylene glycol, or tetramethylene glycol; trihydric alcohols such as glycerin or trimethylol propane; polyhydric alcohols such as pentaerythrit, dipentaerythrit, mannit, or sorbit; and polyester resins obtained via condensation reaction with polyols including bisphenols such as 2,2-diphenylpropane(bisphenol A).

The intermediate layer of the present invention may be formed by coating and drying a coating solution prepared by dissolving a resin having the glass transition temperature in a solvent. Examples of the solvent include lower alcohols such as methanol, ethanol, n-propanol, or n-butanol; chlorine atom-containing hydrocarbons such as methylene chloride or ethylene chloride; ketones such as-acetone, methyl ethyl ketone, or methyl isobutyl ketone; aromatic compounds such as toluene, benzene, cyclohexane, cyclohexanone, or xylene; esters of lower fatty acids and lower alcohols such as methyl acetate, ethyl acetate, or butyl acetate; ethers such as dioxane, ethylene glycol monoethyl ether, or ethylene glycol monomethyl ether; and mixtures thereof.

The intermediate layer contains a resin having a glass transition temperature, and the content thereof is preferably in the range of 90-100% by weight. The intermediate layer may contain constituents such as surfactants in addition to the resin.

The film thickness of the intermediate layer is preferably 0.1-20 μm from the viewpoint of impact resistance, but is more preferably 0.2-2.5 μm.

Further, the glass transition temperature (Tg) is preferably 30-100° C. in view of producing a remarkable effect of the present invention, but is more preferably 50-80° C.

The process of heating to at least the glass transition temperature according to the present invention is carried out after or during forming the scintillator layer. Specifically, it is preferable to carry out this process during formation of the following scintillator layer.

(Scintillator Layer)

A scintillator layer, formed on the light-absorbing layer described above, will now be described.

The scintillator layer is a layer containing a radiation phosphor, which emits fluorescence when irradiated with radioactive rays.

The radiation phosphor employed for the present invention is preferably cesium iodide (CsI) for the following reasons: CsI exhibits a relatively high conversion rate of radioactive rays to visible light, and is readily formed into a columnar crystal structure as a phosphor via deposition; and therefore, scattering of the emitted light in the crystals is inhibited via the light guiding effect produced by the crystal structure, resulting in the possibility of forming a thick scintillator layer.

However, since CsI exhibits poor emission efficiency by itself, various types of appropriate activators are added. A mixture of CsI and sodium iodide (NaI), prepared in any selected mixing ratio, is exemplified, as described in Japanese Patent Publication No. 54-35060.

Recently, further, for example, as described in Japanese Patent Publication Open to Public Inspection No. 2001-59899, a production method of X-ray phosphors has been devised, in which CsI is deposited, and an activator such as indium (In), thallium (Tl), lithium (Li), potassium (K), rubidium (Rb), or sodium (Na) is sputtered.

Further, it is possible to form a structure using cesium bromide (CsBr) or cesium chloride (CsCl) instead of CsI utilized as the phosphor, that is, a base substance. Still further, the scintillator layer 3 may be formed into a crystal structure using mixed crystals, as the base substance, prepared by mixing at least two phosphors selected from CsI, CsBr, and CsCl in ary selected mixing ratio.

The scintillator layer 4 may be formed via methods conventionally known in the art, but in the present invention, the scintillator layer is preferably formed via a vapor deposition method.

FIG. 3 is a schematic view of a deposition apparatus utilized to form a scintillator layer on a substrate having an intermediate layer via a vapor deposition method.

In the drawing, the numeric designation 20 represents a deposition apparatus. The deposition apparatus 20 is equipped with a vacuum container 22 incorporating a substrate holder 25, which holds the substrate 1 carrying the reflection layer 2 and the intermediate layer 3; an evaporation source 23 serving to deposit vapor; a substrate rotating mechanism 24 which allows the evaporation source 23 to deposit the vapor by pivoting the substrate holder 25 against the evaporation source 23; and a vacuum pump 21 serving to exhaust air from the vacuum container 22 and to introduce air thereinto.

Since a scintillator layer-forming material contained in the evaporation source 23 is heated via a resistance heating method, the source may be composed not only of an alumina crucible wrapped with a heater but of a boat, or a heater made of a high melting point metal. Further, the scintillator layer-forming material may be heated via an electron beam heating method or a high frequency induction heating method in addition to the resistance heating method, but in the present invention, the resistance heating method is preferable since it has a relatively simple structure, and is easy to handle, inexpensive, as-well as being applicable to a wide variety of materials.

Further, it is preferable that the substrate holder 25 is fitted with a heater (not shown) serving to heat the substrate 1 carrying the reflection layer 2 and the intermediate layer 3. Still further, it is preferable that the deposition apparatus 20 is quipped with a heater (not shown) serving to elevate the ambience temperature in the apparatus.

These heaters are capable of heating the intermediate layer to at least the glass transition temperature.

A shutter (not shown) may be arranged between the intermediate layer 3 and the evaporation source 23 to divide the space between them. It is possible for the shutter to prevent substances, other than the objective one, having adhered to the surface of the scintillator layer-forming material from adhering to the intermediate layer 3 via evaporation in the initial stage of deposition.

In the scintillator panel of the present invention, the most preferred embodiment is that the scintillator layer, composed of columnar crystals containing CsI as the main constituent, is formed on the intermediate layer.

In a production method of the scintillator panel of the present invention, the scintillator layer is formed via a deposition process, and during the deposition process, a process of heating a resin contained in the intermediate layer to at least the glass transition temperature is carried out.

With respect to the heating process, the intermediate layer may be heated by elevating the ambience temperature during the deposition process.

FIG. 4 is a drawing, which exemplifies a shape of the surface of the intermediate layer on the scintillator side, as well as schematically exemplifying a case in which the scintillator layer is formed into the columnar crystals 6. The shape of the surface of the intermediate layer on the scintillator side is a surface shape thermally deformed to conform to the shape of the surface of the scintillator layer facing the intermediate layer.

In the scintillator panel prepared via the production method of the present invention, specifically, with respect to the shape of the intermediate layer, the surface thereof on the scintillator layer side is thermally deformed to conform to the shape of the surface of the scintillator layer facing the intermediate layer, in which, for example, hole sections 7 are formed via thermal deformation.

According to the present invention, the thermally deformed shape to conform to the surface shape, is a shape thermally deformed, wherein portions corresponding to the convex portions of the scintillator layer surface are equivalent to the hole sections of the intermediate layer, and portions corresponding to the concave portions of the scintillator layer surface are equivalent to the convex portions of the intermediate layer.

Namely, a preferred embodiment of the present invention is that in a scintillator panel incorporating a substrate, a reflection layer formed thereon, an intermediate layer formed on the reflection layer, and a scintillator layer formed on the intermediate layer, the scintillator panel, characterized as follows, is preferable: the intermediate layer contains a resin having a glass transition temperature; and via a process of heating the intermediate layer to at least the glass transition temperature of the resin, the shape of the surface of the intermediate layer on the scintillator layer side is thermally deformed to conform to the shape of the surface of the scintillator layer facing the intermediate layer.

A depth of the hole sections 7 is preferably 0.001-0.5 μm, but is more preferably 0.001-0.1 μm. Further, an area of the hole sections is 0.001-10 μm², depending to the types of crystals employed for the scintillator layer.

(Radiation Image Sensor)

FIG. 2 is a cross-sectional view of a radiation image sensor of the present invention.

The radiation image sensor 30 of the present invention is provided with the photodetector 5 facing the scintillator layer 4.

The photodetector 5 of the present invention, functioning to convert light emitted by the scintillator layer to electrical signals, is provided with photoelectric conversion members including solid-photo detection elements such as photodiode, CCD, or CMOS sensors. Detected electrical signals are output as radiation image signals via A/D conversion to be used as image data.

### EXAMPLE

The present invention will now be detailed by referring to examples; however the present invention is not limited thereto.

(Preparation of a Reflection Layer)

A reflection layer (0.01 μm) was formed by sputtering aluminum onto a polyimide film of a 125 μm thickness (UPILEX-125S: produced by Ube Industries, Ltd.).

(Preparation of an Intermediate Layer)

| | |
|---|---|
| VYLON 200 (polymeric polyester resin: produced | 100 parts by weight |
| by Toyobo Co., LTD.) (glass transition temperature: | |
| 67° C.) | |
| Methyl ethyl ketone (MEK) | 100 parts by weight |
| Toluene | 100 parts by weight |

A coating solution used to form an intermediate layer was obtained by mixing the above formulation, followed by dispersing the resultant mixture for 15 hours using a bead mill. The coating solution was coated onto the aluminum, having been sputtered on the substrate, using a bar coater to form a film having a dried thickness of 1.5 μm. The glass transition temperature of the coated film was 67° C.

(Formation of a Scintillator Layer)

A scintillator (namely “phosphor”) layer was formed by depositing a scintillator phosphor (CsI:0.003Tl) onto the substrate surface to be arranged on the intermediate layer side using the deposition apparatus shown in FIG. 3.

Initially, a raw material of phosphor used as the deposition material, was placed in the resistance heating crucible, and a substrate was attached to the rotatable substrate holder, followed by the adjustment of the distance between the substrate and the deposition source to 400 mm.

Subsequently, the interior of the deposition apparatus was firstly exhausted, and arcon gas was introduced to adjust the vacuum degree at 0.5 Pa, followed by rotating the substrate at 10 rpm.

Further, the intermediate layer temperature was kept at 200° C. using a heating device (not shown) placed in the deposition apparatus. Simultaneously, the substrate was kept at the same temperature as for the intermediate layer. Subsequently, the phosphor was deposited by heating the resistance heating crucible, followed by terminating the deposition when the film thickness of the scintillator layer became 500 μm to obtain a scintillator panel (namely a radiation image conversion panel).

<Evaluation>

The sample obtained above was sealed, and then placed on a CMOS flat panel (X-ray CMOS camera system Shad-o-Box 4 KEV: produced by Rad-icon Imaging Corp.) to obtain Radiation Image Sensor 1-1.

Using Radiation Image Sensor 1-1, sharpness was determined from 12 bit output data, and then evaluated in the following manner.

Herein, a sponge sheet was placed between the carbon plate of the radiation entry window and the radiation entry side (the side on which no phosphor was present) of the scintillator panel in order to fix the surface of the flat photo detecting element and the scintillator panel via gentle pressure.

<Evaluation Method of Sharpness>

Each of the specimens was irradiated with X-rays of a tube voltage of 80 kvp from the backside (namely the surface on which no scintillator layer was formed) through a lead MTF chart. Image data was detected by the CMOS flat panel provided with the scintillator, and then recorded on a hard disk. Subsequently, the recorded data on the hard disk was analyzed using a computer to determine the modulation transfer function MTF (MTF value at a spatial frequency of 1 c/mm) of the X-ray image, which is an indicator for sharpness.

Further, a 5 kg iron ingot was allowed to collide with Radiation Image Sensor 1-1 at 0.5 m/sec in the direction perpendicular to the gravity direction. Radiation Image Sensor 1-2 obtained via the collision was evaluated in the same manner as described above.

Radiation Image Sensor 2-1 was obtained in the same manner as for Radiation Image Sensor 1-1 except that no intermediate layer was formed, and therefore the layer was not subjected to a heating process in preparation of Radiation Image Sensor 1-1. Radiation Image Sensor 2-1, and Radiation Image Sensor 2-2 obtained by allowing the iron ingot to collide with Radiation Image Sensor 2-1 in the same manner were evaluated in the same manner as described above.

Radiation Image Sensor 3-1 was obtained in the same manner as for Radiation Image Sensor 1-1 except that a substrate and an intermediate layer were not subjected to a heating process in preparation of Radiation Image Sensor 1-1. Radiation Image Sensor 3-1, and Radiation Image Sensor 3-2 obtained by allowing the iron ingot to collide with Radiation Image Sensor 3-1 in the same manner were evaluated in the same manner as described above.

Radiation Image Sensor 4-1 was obtained in the same manner as for Radiation Image Sensor 1-1 except that no intermediate layer was formed in preparation of Radiation Image Sensor 1-1. In this case, the temperature of the substrate was kept at 200° C. using the heating device (not shown) placed in the deposition apparatus. Radiation Image Sensor 4-1, and Radiation Imace Sensor 4-2 obtained by allowing the iron ingot to collide with Radiation Image Sensor 4-1 in the same manner were evaluated in the same manner as described above.

Incidentally, sharpness evaluation was calculated as follows: the modulation transfer function MTF of the branch number 2, for example, shown in Image Sensor 1-2 was represented by a relative value when the modulation transfer function MTF of the branch number 1, for example, shown in Image Sensor 1-1 is 1.0.

Hereinafter, values obtained in the above manner are designated as relative MTF values. An image sensor featuring a higher relative MTF value is superior in sharpness. MTF refers to an abbreviation for Modulation Transfer Function. The obtained radiation image sensors were evaluated by calculating a total of four relative values. The radiation image sensors evaluated are listed in Table 1.

TABLE 1

| | Presence or | | Presence or |
|---|---|---|---|
| | Absence of | Presence or | Absence of |
| | Intermediate | Absence of | Iron Ingot |
| Radiation Image Sensor | Layer | Heating | Collision |
| Radiation Image Sensor | Present | Present | Absent |
| 1-1 | | | |
| Radiation Image Sensor | Present | Present | Present |
| 1-2 | | | |
| Radiation Image Sensor | Absent | Absent | Absent |
| 2-1 | | | |
| Radiation Image Sensor | Absent | Absent | Present |
| 2-2 | | | |
| Radiation Image Sensor | Present | Absent | Absent |
| 3-1 | | | |
| Radiation Image Sensor | Present | Absent | Present |
| 3-2 | | | |
| Radiation Image Sensor | Absent | Present | Absent |
| 4-1 | | | |
| Radiation Image Sensor | Absent | Present | Present |
| 4-2 | | | |

The results are listed below.

TABLE 2

| | | Relative MTF |
|---|---|---|
| | | Value |
| | | after Iron |
| Radiation Image Sensor | Remarks | Ingot Collision |
| Radiation Image Sensor | Present | 0.99 |
| 1-2 | Invention | |
| Radiation Image Sensor | Comparative | 0.75 |
| 2-2 | Example 1 | |
| Radiation Image Sensor | Comparative | 0.78 |
| 3-2 | Example 2 | |
| Radiation Image Sensor | Comparative | 0.74 |
| 4-2 | Example 3 | |

As shown in Table 2, the relative MTF value of Image Sensor 1-2, obtained from Image Sensor 1-1 via the collision, was 0.99.

The relative MTF value of Image Sensor 2-2, obtained from Image Sensor 2-1 via the collision, was 0.75, wherein Image Sensor 2-1 incorporated no intermediate layer, and the substrate had not been subjected to the heating process as described above.

The relative MTF value of Image Sensor 3-2, obtained from Image Sensor 3-1 via the collision, was 0.78, wherein Image Sensor 3-1 incorporated a substrate and an intermediate layer, neither of which had been subjected to the heating process.

Further, the relative MTF value of Image Sensor 4-2, obtained from Image Sensor 4-1 via the collision, was 0.74, wherein Image Sensor 4-1 incorporated no intermediate layer.

The results show that the scintillator panel of the present invention, incorporating an intermediate layer that is subjected to the heating process, exhibits excellent impact resistance.

What is claimed is:

1. A scintillator panel comprising a substrate having thereon a reflection layer, an intermediate layer, and a scintillator layer in the sequence set forth,
wherein the intermediate layer comprises a resin having a glass transition temperature, and the intermediate layer has been subjected to a process of heating to a temperature of equal to or grater than the glass transition temperature of the resin.

2. The scintillator panel of claim 1,
wherein the glass transition temperature of the resin is from 30 to 100° C.

3. The scintillator panel of claim 1,
wherein the resin in the intermediate layer is a polyester resin.

4. The scintillator panel of claim 1,
wherein the intermediate layer has a thickness of 0.2 to 2.5 μm;

5. The scintillator panel of claim 1,
wherein the reflection layer comprises aluminum.

6. The scintillator panel of claim 1,
wherein after the intermediate layer has been subjected to the process of heating, a surface of the intermediate layer facing the scintillator layer is thermally deformed to conform to a shape of a surface of the scintillator layer facing the intermediate layer.

7. A radiation image sensor comprising the scintillator panel of claim 1 and a photodetector facing the scintillator layer of the scintillator panel.

8. A method of producing the scintillator panel of claim 1 comprising the process of:
forming on the substrate, the reflection layer, the intermediate layer and the scintillator layer in that order,
wherein the scintillator layer is provided via a deposition method, and the process of heating the intermediate layer to a temperature of equal to or grater than the glass transition temperature of the resin is carried out during the formation of the scintillator layer via the deposition method.
